(19) United States
(12) Patent Application Publication
(10) Pub. No.: US 2012/0033411 A1
(43) Pub. Date: Feb. 9, 2012

(54) SAFETY VEST

(76) Inventor: Jae Yong Heo, Seoul (KR)

(21) Appl. No.: 13/264,920

(22) PCT Filed: Apr. 19, 2010
(86) PCT No.: PCT/KR2010/002403

§ 371 Date: Oct. 25, 2011

(30) Foreign Application Priority Data
Apr. 17, 2009 (KR) 10-2009-0033384

(51) Int. Cl. F21L 4/02

(52) U.S. Cl. 362/108

(57) ABSTRACT

The present invention relates to a safety vest, and more specifically, to a safety vest which has an LED, a light emitting device, adhered thereto, wherein the LED is covered with a light transmitting unit comprising a thin film light transmitting portion and a thick film light transmitting portion to protect the LED from external shock and to allow the vest to be recognized by other people by improving visibility from both long and short distances and also from the front and the sides, and a buoyancy generation means is provided to allow the vest to play a role as a life vest in water without a decrease in the worker's work ability.

### TECHNICAL FIELD

The present invention relates to a safety vest, and more specifically, to a safety vest which has an LED, a light emitting device, adhered thereto, wherein the LED is covered with a light transmitting unit comprising a thin film light transmitting portion and a thick film light transmitting portion to protect the LED from external shock and to allow the vest to be recognized by other people by improving visibility from both long and short distances and also from the front and the sides, and a buoyancy generation means is provided to allow the vest to play a role as a life vest in water without a decrease in the worker's work ability.

### BACKGROUND ART

As trades between countries these days, the amount of trade goods loaded/unloaded at a wharf increased, and work at the wharf is frequently conducted at night so as to process a large amount of trade goods or to set a date for exports. In the work at the wharf, particularly, the work at night, a worker conducts work while wearing a safety vest so as to prevent the worker from being involved in an unexpected accident by informing other peopled of the worker's position.

A conventional safety vest is composed of a belt and a shoulder strap. A luminous paint is coated on outer surfaces of the belt and the shoulder strap, or a luminous tape is stuck to the outer surfaces of the belt and the shoulder strap. Thus, a luminous part is shone by external light so that other people can recognize the existence of the worker.

However, since the conventional safety vest emits light only when receiving the light from the outside, the conventional safety vest does not emit light at a place light-shielded from the outside. Particularly, when it is snowy, rainy or foggy or when light shone from the outside is weak, the safety vest does not properly emit light, and therefore, it is difficult to recognize the existence of a worker from the outside. Such a problem may be faced by anyone who works at a dangerous place, such as a traffic police on the road, a worker in a ship and a street cleaner, as well as a wharf man.

Since a wharf man or worker in a ship works on the seashore, the wharf man or worker may be drowned into the sea due to instantaneous carelessness at work. Particularly, at night, it is not easy to detect the position of the worker drowned in the sea, and therefore, it takes much time to rescue the worker. Accordingly, the worker should conduct work while wearing a safety vest. However, since the wharf man or worker should conduct allotted work, it is very inconvenient for the worker to conduct the work while wearing the safety vest. Therefore, a safety vest is required to enable the worker to smoothly conduct the work and to play a role as a life vest without a decrease in the worker's work ability.

Particularly, when a worker working in a ship floated on the middle of the sea is wrecked, the worker should float on the surface of the sea until a rescue ship approaches the worker, and further, the position of the wrecked worker should be easily detected from the rescue ship. However, the conventional safety vest is not competent enough to play such a role.

### DISCLOSURE OF INVENTION

### Technical Problem

Embodiments provide a safety vest which has an LED, a light emitting device, adhered thereto, wherein the LED is covered with a light transmitting unit comprising a thin film light transmitting portion and a thick film light transmitting portion to protect the LED from external shock and to allow the vest to be recognized by other people by improving visibility from both long and short distances and also from the front and the sides, and a buoyancy generation means is provided to allow the vest to play a role as a life vest in water without a decrease in the worker's work ability.

### Technical Solution

According to an aspect of the present invention, there is provided a safety vest having a belt for surrounding a person's waist and shoulder straps connected to the belt respectively thrown on person's shoulders, the safety vest comprising: a plurality of LED assemblies attached to a surface of the safety vest; a battery for supplying power to the LED assemblies; and a switch for controlling the power of the battery, wherein each of the LED assemblies comprises: at least one LED; a light transmitting unit configured to protect the LED from external shock by surrounding an emission part of the LED and transmit light of the LED to an outside thereof, the light transmitting unit comprising at least one thin film light transmitting portion of which thickness is thin in the light transmitting unit so as to ease the glare of intense light just in front of the LED and to improve visibility at a long distance, and at least one thick film light transmitting portion of which thickness is thicker than that of the thin film light transmitting portion in the light transmitting unit so as to emit the light to sides of the LED by widely diffusing the light of the LED; and a fixing part positioned on a bottom surface of the LED.

At least one sealing part having a sealed inside may be provided to the safety vest, and an air injection valve through which air may be injected into or deflated from the sealing part is provided to the sealing part.

At least one accommodating part may be provided to the safety vest, a gateway through which an air bag is inserted into or separated from the accommodating part may be provided to the accommodating part, and an opening/closing means may be provided to the gateway.

The sealing part or accommodating part may be formed on only parts of the belt or shoulder strap, which come in contact with person's chest and back.

A folding line may be formed at a central part in a thickness direction of the accommodating part or sealing part.

A folding line may be formed at a central part in a thickness direction of the accommodating part or sealing part, and when air is deflated from the accommodating part or sealing part, an attaching means may be formed at front and rear parts of the folding line so that the front and rear parts of the folding line is adhered closely to each other about the folding line.

The LED may be a high-brightness LED.

The LED assembly, the battery and the switch may have a waterproof function.

The LED assembly may further comprise a base, and the base may comprise a support part having the fixing part accommodated in an inside thereof and having a frame provided thereto; a sidewall connected upward from the support part so as to surround the LED; and a wire connection groove having an electric wire accommodated therein, wherein the electric wire is formed by horizontally passing through the support part so as to be connected to the LED by connection screws respectively passing through positive and negative electrodes of the LED formed on the fixing part.

The LED assembly may further comprise a base, and the base may comprise a support part having a bottom opening through which the LED is inserted into the light transmitting unit at a bottom thereof; and a sidewall connected upward from the support part so as to surround the LED.

A concave part having a relatively small diameter may be formed in the light transmitting unit.

At least one fixing pin may be attached to a bottom of the fixing part.

A light diffusion cap surrounding the LED may be formed at an outside of the LED, a bottom of the light diffusion cap may be coupled to the fixing part, the light diffusion cap may have a shape in which a thin wall is formed along a side of the LED from the bottom of the fixing part, and a convex, concave or flat lens for light diffusion may be then formed above the LED.

A polycarbonate layer may be additionally attached to a top of the light passing unit.

A diffusion layer may be additionally attached to an inside of the light transmitting unit, opposite to a top of the LED.

At least one air exhaustion groove or embossing may be formed on a side surface of the light-passing unit, which comes in contact with the LED.

The fixing part may have a connector shape.

A distress signal transmitter may be attached to the safety vest.

### Advantageous Effects

In the safety vest according to the present invention, an LED is covered with a light transmitting unit so as to protect the LED from external shock, so that it is possible to prevent the LED from being damaged.

Since the safety vest uses a specifically designed LED assembly having a light transmitting unit, so that it is possible to allow the safety vest to be recognized by other people in working and emergency situations by improving visibility from both long and short distances and also from the front and the sides. Thus, it is possible to protect a wearer from an unexpected accident. Further, it is possible to easily detect the position of the wearer.

Light emitted from the LED advances straight and therefore may interference the sight of an adjacent worker placed in front of the LED. Hence, when only the LED is attached to the safety vest, the sight of the adjacent worker is interfered. However, the LED assembly according to the present invention passes through the light transmitting unit, so that it is possible to prevent the adjacent worker from be instantaneously interfered by the glare of intense light just in front of the LED. Further, the light transmitting unit also prevents the LED from being damaged in working.

Since the safety vest according to the present invention is provided with a buoyancy generation means, the worker can survive for a long period of time in water when the worker is drowned in the water. Since the buoyancy generation means is formed at waist, chest and back parts of the worker, the worker's feeling of wearing the safety vest is good, and the movement of the worker is not particularly limited.

Since the buoyancy generation means can be attached/detached to/from the safety vest, the worker removes the buoyancy generation means from the safety vest and then wears the safety vest in working at a place where the worker may be drowned in water. Thus, it is possible to maximize the worker's feeling of wearing the safety vest and work efficiency depending on a place where the safety vest is used.

Since the LED assembly used in the present invention has a wide range of light irradiated to the front and sides of the LED, the LED assembly can obtain the same effect as the conventional LED assembly while using a smaller number of LEDs. Thus, as the LED assembly used in the present invention uses a smaller number of LEDs in the same light irradiation range as compared with the conventional LED assembly, the LED assembly has relatively less power consumption than the conventional LED assembly. Accordingly, a battery can be used for a long period of time, and it is suitable to use solar energy that is environment friendly but has low efficiency.

### DESCRIPTION OF DRAWINGS

FIG. 1 is a schematic view of a safety vest according to the present invention.

FIG. 2 is a sectional view of an LED assembly used in the present invention.

FIG. 3 is a sectional view of the LED assembly having a base.

FIG. 4 is a plan view of the LED assembly in the state that a light transmitting unit is removed from the LED assembly.

FIG. 5 is a sectional view of the base as another embodiment.

FIG. 6 is a sectional view of the LED assembly having fixing pins attached thereto.

FIG. 7 is a sectional view of the LED assembly having a concave part formed therein.

FIG. 8 is a sectional view showing a coupled state between an LED and the light transmitting unit when the LED and the light transmitting unit are separated from each other.

FIG. 9 is a sectional view of the LED assembly having a support platform additionally mounted therein.

FIG. 10 is a schematic view of the LED assembly having a light diffusion cap additionally formed therein.

FIG. 11 is a sectional view of the LED assembly having a polycarbonate layer attached thereto.

FIG. 12 is a sectional view of the LED assembly having a diffusion layer attached thereto.

FIG. 13 is a sectional view of a fixing part having a connector shape.

FIG. 14 is a sectional view of the LED assembly having two air exhaustion grooves formed therein.

FIG. 15 is a cross-sectional view taken along line A-A of FIG. 13.

FIG. 16 is a sectional view of the LED assembly having embossings formed therein.

FIG. 17 is a schematic view of the safety vest having a sealing part formed thereon.

FIG. 18 is a view showing another embodiment of the sealing part, which shows an enlarged view of part A in FIG. 17.

FIG. 19 is a schematic view of the safety vest having a shoulder strap with an accommodating part as another embodiment of the present invention.

FIG. 20 is a schematic view of the safety vest having a distress signal transmitter attached thereto.

FIG. 21 is a schematic view showing a state that a person wearing the safety vest according to the present invention is drowned in water.

### BEST MODE

In a safety vest according to the present invention, a specifically designed LED assembly is attached to the conventional safety vest, so that the safety vest according to the present invention is light and strong against damage and can improve visibility, thereby preventing an unexpected accident. Further, the safety vest according to the present invention has a buoyancy generation means without a decrease in the worker's work ability, so that it is possible to maximize worker's survival time and to allow the worker to be easily rescued.

The present invention now will be described more fully hereinafter with reference to the accompanying drawings, in which embodiments of the invention are shown. This invention should not be construed as limited to the embodiments set forth herein. Rather, these embodiments are provided so that this disclosure will be thorough and complete, and will fully convey the scope of the invention to those skilled in the art.

FIG. 1 is a schematic view of a safety vest having a light emitting device according to the present invention. As shown in FIG. 1, the safety vest 200 according to the present invention comprises a belt 210, shoulder straps 215, LED assemblies 100, a battery 600 and a switch 700.

The belt 210 and the shoulder straps 215 may be ones used for a typical safety vest. The belt 210 may surround a person's waist, and may be provided with a coupling means and a length adjusting means, such as a buckle. The shoulder straps 215 are connected to the belt 210 so as to prevent the safety vest from being slept down. The shoulder strap 215 may be provided with a length adjusting means.

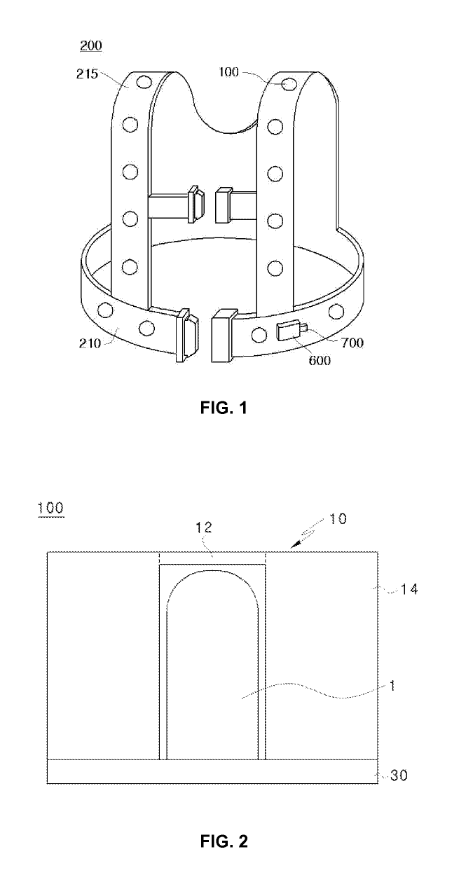

As shown in FIG. 1, the plurality of LED assemblies 100 are attached at a predetermined interval to the safety vest 200 according to the present invention. FIG. 2 is a sectional view of an LED assembly used in the present invention. As shown in FIG. 2, the LED assembly 100 according to the present invention comprises an LED 1, a light transmitting unit 10 and a fixing part 30. Hereinafter, each of the parts will be described.

The shape of the LED used in the present invention is not particularly limited. For example, the emission part of the LED may be long as shown in FIG. 1, and the emission part of the LED may be short. In a case where the emission part of the LED is short, the brightness at sides of the LED may be more intense as compared with FIG. 1. Further, in a case where the emission part of the LED is short, the shape of the light transmitting unit may be changed depending on the shape of the emission part of the LED. In addition, it will be apparent that an LED of which emission part has a short but wide shape and an LED having a round shape may be applied to the present invention. Preferably, a high-brightness LED is used as the LED used in the present invention so as to improve visibility.

The number of LEDs used in the present invention is at least one. Here, the number of LEDs is not particularly limited. In a case where a plurality of LEDs are mounted in the LED assembly, the LEDs having different colors may be mounted in the LED assembly. Further, the LEDs may be mounted at different angles from one another in the LED assembly. This is provided to improve visibility at various angles in consideration of the straightness of light emitted from the LEDs.

The light transmitting unit 10 surrounds the emission part of the LED 1 and transmits light of the LED 1 to the outside thereof. The light transmitting unit has a flat bottom surface. The light transmitting unit 10 prevents light from scattering and limits light irradiation range to the size of the light transmitting unit, so as to increase the degree of concentration of light, to reflect various expressions of light according to the shape of the light transmitting unit, and to enable several colors, shapes and brightnesses to be expressed in one LED assembly. Since the light transmitting unit 10 surrounds the emission part of the LED 1, the light transmitting unit functions to protect the LED 1 from an external impact applied to the LED 1. Light emitted from the LED 1 is emitted to the outside of the LED assembly through the light transmitting unit 10. While passing through the light transmitting unit 10, the light is reflected, diffracted and the like. In the present invention, the shape of the light transmitting unit 10 is not particularly limited. However, in order to more improve visibility, the light transmitting unit 10 preferably comprises at least one thin film light transmitting portion 12 and at least one thick film light transmitting portion 14.

The thin film light transmitting portion 12 is a thin part of the light transmitting unit so as to cast the light of the LED 1 up to a long distance, particularly to ease the glare of intense light just in front of the LED. The thick film light transmitting portion 14 is a part thicker than the thin film light transmitting portion 12 in the light transmitting unit so as to highlight the shape of the light-passing unit by widely spreading the light of the LED 1 so that light is easily recognized even at sides of the LED 1. In the thin film light transmitting portion 12, the thickness of a medium through which the light of LED 1 passes is thin, and therefore, almost of the light passes through the thin film light transmitting portion without loss of energy. Thus, people at a relatively long distance can recognize the light emitted from the thin film light transmitting portion 12. Further, a thin film exists in the thin film light transmitting portion 12, and therefore, it is possible to ease the glare of intense light just in front of the front side of the LED.

The thickness of the thin film light transmitting portion 12 is changed depending on the brightness of the LED mounted in the LED assembly. In a general LED, the thickness of the LED is preferably 0.1 to 10 mm. If the thickness of the LED is less than 0.1 mm, the glare of intense light occurs just in front of the LED. If the thickness of the LED exceeds 10 mm, it is difficult to case light of the LED up to a long distance because the light is interrupted by the light transmitting unit.

The thin film light transmitting portion 12 casts light to a long distance and ease the glare of intense light just in front of the LED, thereby improving the entire visibility of the LED assembly.

The thin film light transmitting portion 12 may be formed by making a hole in the inside of the light transmitting unit 10 so that the light transmitting unit with the hole is thinner than its surroundings or by forming a part from which light is intensely emitted on the outer surface of the light transmitting unit to be thinner than its surroundings.

In FIG. 2, the thin film light transmitting portion 12 has a flat shape when being viewed from a side of the thin film light transmitting portion. However, the thin film light transmitting portion may have a convex shape in which light can be diffused or a concave shape in which light can be gathered.

The thick film light transmitting portion 14 is a part thicker than the thin film light transmitting portion 12 in the light transmitting unit. Since a medium of the thick film light transmitting portion is thick, a part of the light passing through the medium is reflected in the inside of the thick film light transmitting portion so that the light is spread throughout the entire of the thick film light transmitting portion 14 and emitted to the outside of the light transmitting unit. Thus, the light emitted from the thick film light transmitting portion 14 is darker than that emitted from the thick film light transmitting portion 12, but is entirely spread, so that it is possible to recognize the shape of the light transmitting unit not only in front of the front side of the LED 1 but also at sides of the LED 1.

As a result, the light emitted from the thin film light transmitting portion 12 is casted in a direction of the front side of the LED 1 up to a long distance, so that it is possible to enable people at the long distance to easily recognize the light and to ease the glare of intense light just in front of the front side of the LED. Accordingly, it is possible to recognize the light of the LED 1 at a short distance, particularly just in front of the LED, without the fatigue of eyes. The light emitted from the thick film light transmitting portion 14 is also emitted to the sides of the LED 1, so that people can easily recognize the shape of the light transmitting unit event at the sides of the LED 1, thereby improving the shapability of the LED assembly. The light emitted from the thin film light transmitting portion 12 is bright, and the light emitted from the thick film light transmitting portion 14 is gentle so that the thin film and thick film light transmitting portions 12 and 14 are harmonized, thereby obtaining a remarkable visual effect.

The thickness of the thick film light transmitting portion 14 is not particularly limited. However, the thick film light transmitting portion is preferably 1.5 to 20 times thicker than the thin film light transmitting portion 12 so that light is emitted to the sides of the LED. If the thickness of the thick film light transmitting portion exceeds 20 times, the amount of the light emitted to the outside is too small.

The position of each of the thin film and thick film light transmitting portions 12 and 14 is not particularly limited. However, the thin film light transmitting portion 12 is preferably formed at the front side that is a direction in which the light of LED 1 is most intensely emitted, in consideration of the straightness of light, so that the light emitted from the thin film light transmitting portion is casted up to a long distance. The thick film light transmitting portion 14 is preferably mounted around the thin film light transmitting portion 12.

The number of each of the thin film and thick film light transmitting portions 12 and 14 is not particularly limited, and several thin film and thick film light transmitting portions 12 and 14 may be formed as occasion demands.

The entire shape of the light transmitting unit 10 is not particularly limited. In FIG. 2, the light transmitting unit has a tetrahedral shape, but may have various three-dimensional shapes such as trihedral, pentahedral, hexahedral and hemispheric shapes.

The shape of each of the thin film and thick film light transmitting portions 12 and 14 when being viewed from the top is not particularly limited. The shape of each of the thin film and thick film light transmitting portions is generally a circle, but may be the shape of a specific figure or character including a star, a triangle, a square, an animal pattern, a person's figure, a character pattern, and the like. In this case, the shape of a figure or character formed in the thin film or thick film light transmitting portion 12 or 14 can be recognized from the outside.

Since the thin film light transmitting portion 12 means a part of which thickness is relatively thin in the light transmitting unit, the thin film light transmitting portion 12 may be implemented using a method of forming the light transmitting unit and then engraving a part corresponding to the thin film light transmitting portion 12. Since the thick film light transmitting portion 14 means a part of which thickness is relatively thick in the light transmitting unit, the thin film light transmitting portion 12 may be implemented using a method of forming the light transmitting unit and then embossing a part corresponding to the thin film light transmitting portion 12. Further, a plurality of thin film and thick film light transmitting portions may be implemented by properly combining of embossing and engraving.

The thin film or thick film light transmitting portion 12 or 14 may be coated with a color so as to emphasize the visible effect of the LED assembly. Here, the thin film and thick film light transmitting portions 12 and 14 may be coated with the same color or different colors. The thin film and thick film light transmitting portions 12 and 14 may be simultaneously coated with several colors. Only the outer parts of the thin film and thick film light transmitting portions 12 and 14 may be coated with a color. Light emitted from one LED may be variously expressed by allowing the colors of the LED and the light transmitting unit to be identical to or different from each other.

The material of the light transmitting unit 10 is not particularly limited, and may be a modable and permeable material. For example, the material of the light transmitting unit may be glass, plastic, silicon, latex, rubber, urethane, resin, epoxy resin, polycarbonate, polymer, or the like. Among these materials, the silicon with excellent moldability and strong anti-impact ability is most preferably used.

The thin film or thick film light transmitting portion may be variously formed by combining at least one of transparent, translucent and opaque materials.

The fixing part 30 is a part positioned on bottom surfaces of the LED 1 and the light transmitting unit 10, and functions to attach the LED assembly 100 to the safety vest 200 and fix the LED. As occasion demands, a PCB substrate is positioned at the part, or the part includes the PCB substrate in the inside thereof. Although it has been illustrated in this figure that the fixing part 30 has the same diameter as the light transmitting unit 10, the diameter of the fixing part may be different from that of the light-passing part as occasion demands.

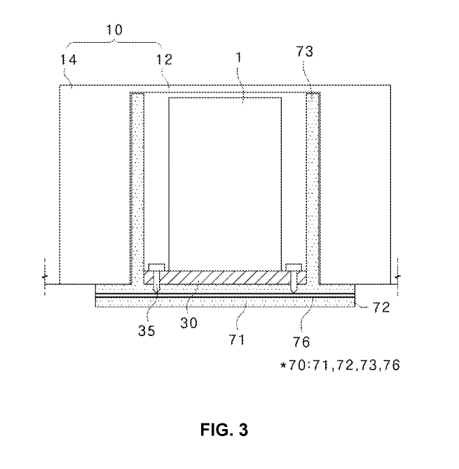

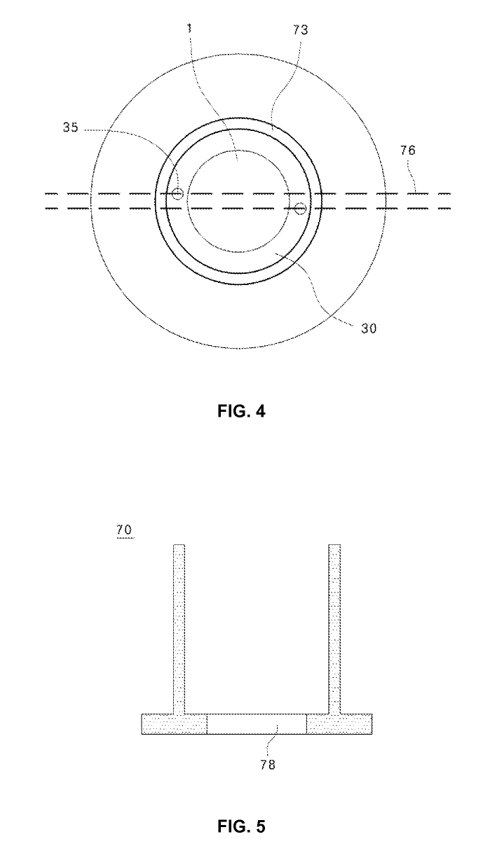

A base may be additionally mounted to the outside of the fixing part. The base may be formed in various shapes. The base basically has a structure which can be coupled to the light transmitting unit by being adhered closely to the light transmitting unit and protect the LED from external shock by accommodating the LED in the inside of the base. FIG. 3 is a sectional view of the LED assembly having a base. FIG. 4 is a plan view of the LED assembly in the state that the light transmitting unit is removed from the LED assembly. The base 70 comprises a support part 71, a sidewall 73 and a wire connection groove 76. A frame 72 of which diameter is greater than that of the fixing part 30 is formed at the support part 71. The diameter of the frame may be adjusted as occasion demands. The sidewall 73 is a part protruded upward from the support part 71, and the light transmitting unit is coupled to the sidewall. Therefore, a coupling means such as a screw groove or coupling projection may be formed at the sidewall so that the light transmitting unit is coupled to the sidewall. The sidewall 73 generally has a cylinder shape, and an internal space having the LED accommodated therein is formed in the inside of the sidewall 73.

The wire connection groove 76 is a groove passing through the support part 71, and an electric wire (not shown) is connected through the wire connection groove. The wire connection groove 76 is necessarily formed at a position at which the electric wire can pass through positive and negative electrodes of the LED 1 formed on the fixing part 30. Connection screws 35 are coupled in vertical directions to positive and negative electrodes of the fixing part 30, respectively. The connection screws 35 vertically pass through the fixing part 30. The electric wire is inserted into the wire connection groove 76 in the state that coating of the electric wire is not peeled off. The connection screw 35 passes through the coating of the electric wire inserted into the wire connection groove 76 while rotating, so that each of the positive and negative electrodes of the LED is electrically connected to the electric wire.

Conventionally, it is inconvenient because the coating of the electric wire is necessarily removed so that the electric wire is connected to the LED. Further, in a case where the position of the LED mounted once is changed, an electric wire is additionally connected, or a remaining electric wire hangs down. Therefore, the electric wire externally looks poor. However, in a case where the base according to the present invention is used, the electric wire is simply connected to the LED. Further, the position of the LED is changed by simply unscrewing the connection screws, changing the position of the LED and then screwing the connection screws. Thus, the electric wire does not hang down due to a remaining electric wire, and it is unnecessary to connect an additional electric wire due to the lack of electric wire.

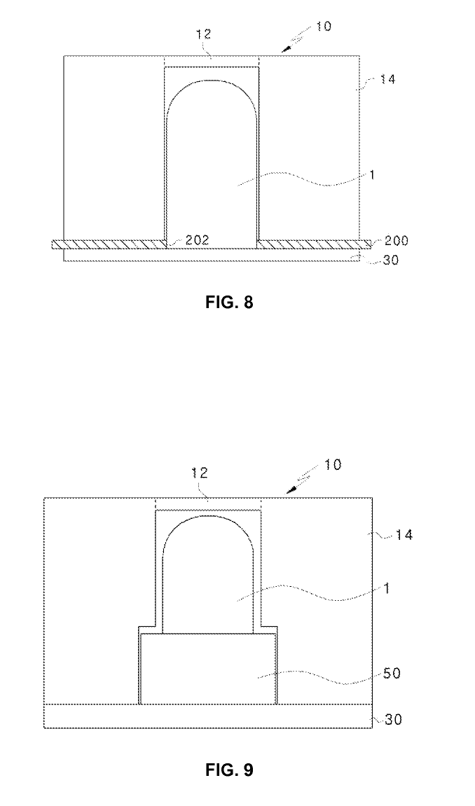

Meanwhile, FIG. 5 is a section view of the base as another embodiment. In this case, a bottom opening 78 is opened at a bottom of the base 70. The bottom opening 78 has a shape through which the LED can be inserted into the light transmitting unit. The wire connection groove is not mounted in the base 70 having the bottom opening 78 formed therein. In the method of coupling the LED assembly to the safety vest 200, the LED assembly is coupled to the safety vest by coupling the base 70 to the light transmitting unit 10 through an insertion hole 202 (see FIGS. 7 and 8) of the safety vest and then inserting the LED into the light transmitting unit through the bottom opening 78.

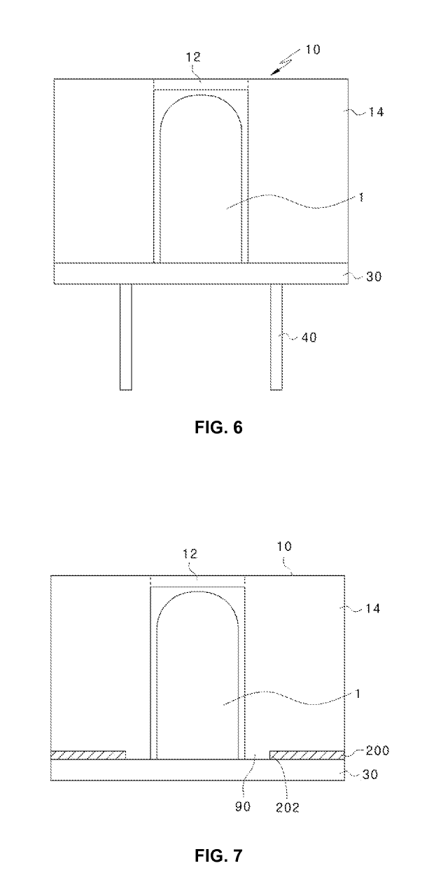

In the method of attaching the LED assembly 100 to the safety vest 200, the entire LED assembly 100 may be formed in a single body so as to be attached to the safety vest 200, or the light transmitting unit 10 and the LED 1 may be formed separately from each other so as to be inserted in to the safety vest 200. In a case where the entire LED assembly is formed in a single body, the LED assembly 100 may be attached to the safety vest 200 using various methods. Here, the attaching method is not particularly limited, but a high-frequency attaching method is most preferably used for the convenience of working process, and the like. In addition, the LED assembly may be attached to the safety vest by attaching a fixing pin 40 such as a flexible iron wire to a bottom of the fixing part, passing the fixing pin 40 through a part of the safety vest, to be attached, and then bending the fixing pin 40. FIG. 6 is a sectional view of the LED assembly having fixing pins attached thereto.

In another attaching method, a plurality of insertion holes are formed at a predetermined interval in the safety vest, and the LED assemblies are inserted into the respective insertion holes. Such a coupling method is generally referred to as a rear insertion method. In this case, the diameter of the insertion hole is formed to be identical to or smaller than that of the light transmitting part so that the light transmitting unit can be completely caught in the insertion hole.

In order to reinforce the strength of the coupling, a concave part having a concave shape may be additionally formed at a bottom part of the light transmitting unit. The concave part has a function of coupling the light-passing unit and the safety vest to each other, and refers to a shape having a groove which is concave, insertable or supportable. FIG. 7 is a sectional view of the LED assembly having a concave part formed therein. In the LED assembly 100. Since the light transmitting unit 10 is made of a soft material, the light transmitting unit is inserted into the insertion hole 202. The concave part 90 may be positioned at the lowermost part of the light transmitting unit 10 as shown in FIG. 7, but may be formed in the middle of the light transmitting unit. The concave part is fixedly inserted into the safety vest.

In a case where the light transmitting unit 10 and the LED 1 are separated from each other, as shown in FIG. 8, the insertion hole 202 is formed in the safety vest, and the light transmitting unit 10 is disposed on the insertion hole 202. Then, the LED 1 and the light-passing unit 10 are coupled with each other by inserting the LED 1 into the insertion hole from the lower part to the upper part of the insertion hole. Such a coupling method is generally referred to as a front insertion method, and the safety vest is fixed between the light transmitting unit and the fixing part. In this case, the LED 1 and the light transmitting unit 10 are adhered closely to each other. On the contrary, the LED 1 may be first inserted into the lower part of the insertion hole 202 and then coupled to the light transmitting unit 10 at the upper part of the insertion hole. In a case where a base is provided, the LED is coupled to the light transmitting unit 10 by inserting the base into the insertion hole.

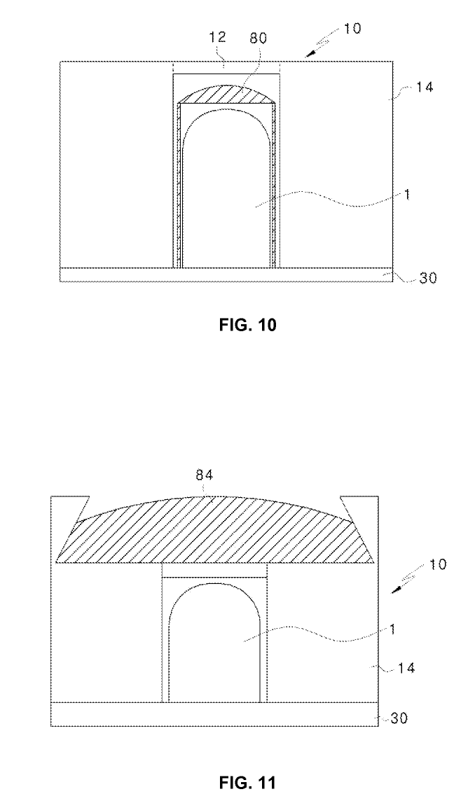

In order to reinforce the strength of the coupling, a support platform 50 may be additionally mounted to the fixing part of the LED 1 using a supporting method using a groove or screw for support. The support platform 50 is a part completely adhered to closely to the light transmitting unit 10 so as to allow the LED 1 to be completely fixed in the light transmitting 10 and prevent damage caused by vibration of the LED 1. FIG. 9 is a sectional view of the LED having a support platform additionally mounted thereto. As shown in FIG. 9, the support platform 50 is completely adhered closely to the side of the light transmitting unit 10.

A power supply unit is a part for supplying power for emission of LEDs. The power supply unit is not particularly limited. For example, the power supply unit may be at least one of an electric condenser, a battery, a DC power source, a solar cell and a hybrid. Preferably, the battery is used as the power supply unit in consideration of convenience of movement and keeping.

The LED assembly attached to the safety vest in the present invention may have a light diffusion cap additionally attached thereto so as to improve visibility at long and short distances. The light diffusion cap may have a convex or concave shape or a flat shape, and maximizes the diffusion and distribution of light of the LED. FIG. 10 is a schematic view of the LED assembly having a light diffusion cap additionally formed therein. The light diffusion cap 80 has a shape surrounding the LED 1, and the bottom of the light diffusion cap 80 is coupled to the fixing part 30. The light diffusion cap has a shape in which a thin wall is formed along a side of the LED 1 from the bottom of the fixing part 30 and a convex, concave or flat lens for light diffusion is then formed above the LED 1. The light diffusion cap 80 may be attached to a vertical wall. In this case, the light diffusion cap has a shape in which the convex, concave or flat lens for light diffusion is attached to the vertical wall. Light emitted from the LED 1 is primarily distributed by the light diffusion cap 80 and secondarily distributed by the thin film and thick film light transmitting portions positioned at the outside of the light diffusion cap 80.

In the LED assembly according to the present invention, a polycarbonate layer may be additionally attached to an upper part of the light transmitting unit so as to improve visibility. Since the polycarbonate layer has high diffusivity of light and high permeability of visible light, the polycarbonate layer radiates light with a very stable feeling. The light primarily diffused through the light transmitting unit is changed into light with a stable feeling while being secondarily diffused through the polycarbonate layer, so that the visibility is entirely improved. FIG. 11 is a sectional view of the LED assembly having a polycarbonate layer attached thereto. As shown in FIG. 11, the polycarbonate layer 84 is attached to an upper part of the light transmitting unit 10. The shape of the attached polycarbonate layer 84 is not particularly limited, but an upper part of the polycarbonate layer is preferably formed in the shape of a convex lens for the purpose of diffusion of light. The method of attaching the polycarbonate layer 84 to the light transmitting unit is not particularly limited. However, the polycarbonate layer 84 may be simply attached to the light transmitting unit by inserting the polycarbonate layer into a groove formed by engraving the upper part of the light transmitting unit.

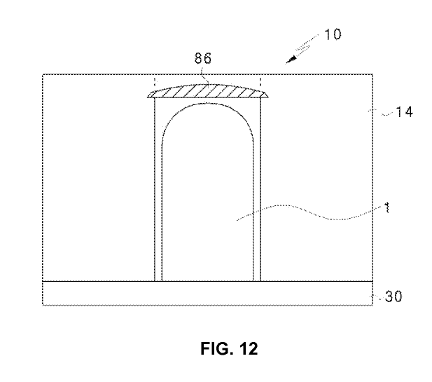

In the LED assembly according to the present invention, a diffusion layer may be additionally attached at a lower part of the light transmitting unit facing the top of the LED so as to broadly diffuse light emitted from the LED. FIG. 12 is a sectional view of the LED assembly having a diffusion layer attached thereto. The diffusion layer 86 is made of a material capable of diffusing light as broad as possible. Particularly, the diffusion layer is preferably made of crystal so as to induce diffused reflection. Light primarily diffused by the diffused reflection induced by the diffusion layer 86 is more broadly diffused while passing through the light transmitting unit 10, so that the light emission range of the LED assembly having is entirely broadened. The method of attaching the diffusion layer 86 to the light transmitting unit 10 is not particularly limited. However, the diffusion layer 86 may be simply attached to the light transmitting unit by inserting the diffusion layer into a groove formed in the light transmitting unit.

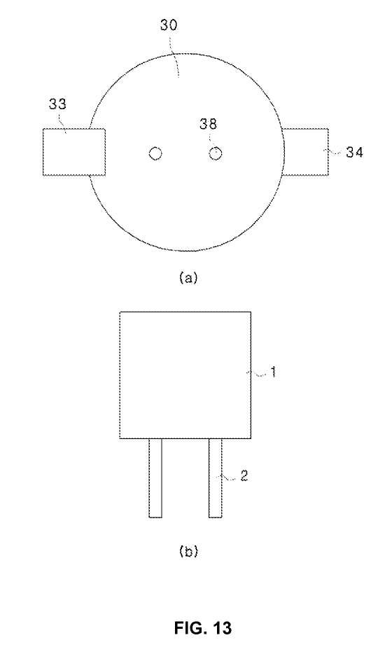

The fixing part according to the present invention may have a connector shape. FIG. 13 is a sectional view of a fixing part having a connector shape. As shown in FIG. 13, the fixing part having the connector shape has a shape in which the LED 1 can be easily replaced. That is, two LED connection grooves 38 through which the LED can be separated from or coupled to the fixing part is formed in the fixing part, and thus two connection parts 2 beneath the LED 1 are coupled to the LED connection grooves, respectively. In a case where a problem occurs in the LED, the LED 1 is separated from the fixing part by opening the light transmitting unit 10 and simply pulling the LED, and the LED is then replaced with a new LED, thereby completing repair. That is, it is possible to easily replace only the LED when it is necessary to replace the LED due to damage or the like.

In the process of inserting the LED 1 into the light transmitting unit 10, air in a part of the light-passing unit 10, into which the LED 1 is inserted, is compressed as the LED 1 is inserted into the light-passing unit. Therefore, when the LED assembly is used for a long period of time, the LED is pushed by the compressed air, and accordingly, the LED 1 and the light-passing unit 10 may be separated from each other. In the present invention, an air exhaustion means may be formed in the inside of the light-passing unit 10 so as to solve such a problem.

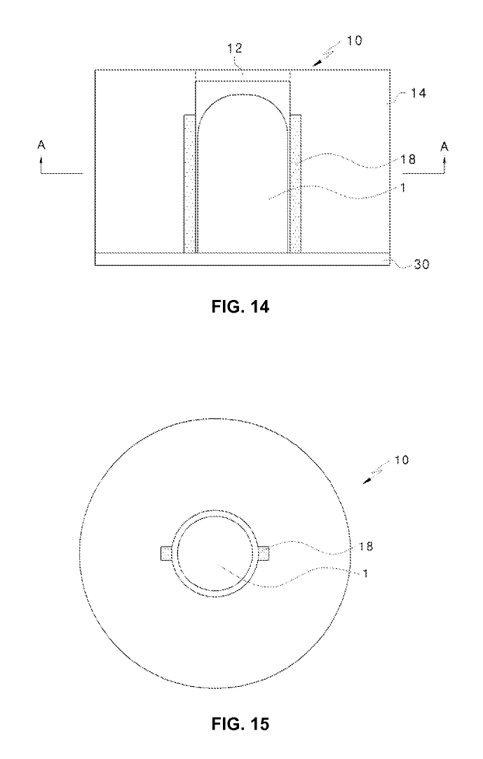

In the present invention, the air exhaustion means may be an air exhaustion groove 18 or embossing 19. FIG. 14 is a sectional view of the LED assembly having two air exhaustion grooves formed therein. FIG. 15 is a partial cross-sectional view taken along line A-A of FIG. 14. As shown in FIGS. 14 and 15, at least one groove is formed in the insertion direction of the LED 1 at a part at which the inside of the light transmitting unit 10 comes in contact with the LED 1. The air exhaustion groove 18 allows the air in the inside of the light transmitting unit 10 to be exhausted to the outside in the process of inserting the LED 1 into the light transmitting unit.

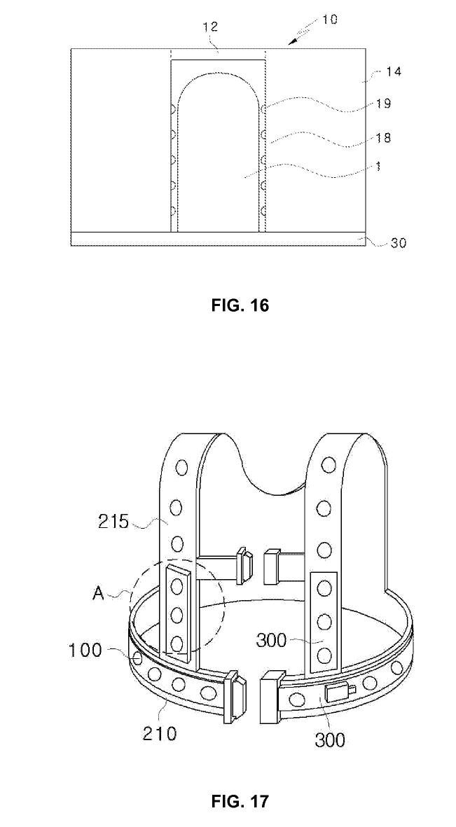

FIG. 16 is a sectional view of the LED assembly having embossings formed therein. As shown in FIG. 16, at least one embossing is formed at the part at which the inside of the light transmitting unit 10 comes in contact with the LED 1. In the process of inserting the LED 1 into the light transmitting unit, the air in the inside of the light transmitting unit 10 is exhausted to the outside through a space between the embossings 19 so as to prevent excessive compressed air from being formed in the inside of the light transmitting unit. Here, the air exhaustion groove 18 or embossing 19 may be formed not only at the side of the LED but also at the side of the support platform as occasion demands.

In the LED assembly of the present invention, a reflection plate is formed on the bottom surface of the light transmitting unit 10, so that light emitted from the LED can be reflected to the front of the LED, thereby more improving visibility.

Although the safety vest according to the present invention may be a simple safety vest, a buoyancy generation means is preferably provided to the safety vest. A tube-shaped sealing part may be used as an example of the buoyancy generation means. The sealing part has the shape of at least one air bag formed on the safety vest. The sealing part is provided with an air injection valve through which air can be injected into the sealing part. The sealing part is preferably formed to allow the safety vest to play a role as a life vest in an emergency situation without interfering activities of a safety vest wearer. Therefore, the sealing part is formed on the belt or shoulder straps of the safety vest. Preferably, the sealing part is formed on only a part of the shoulder strap, at which the safety vest comes in contact with the wearer's chest or back. FIG. 17 is a schematic view of the safety vest 200 having a sealing part formed thereon. As shown in FIG. 17, the sealing part 300 is formed on the belt 210, and the LED assemblies 100 are attached to the outside of the sealing part 300. Although it has been illustrated in FIG. 17 that the sealing part 300 is formed on the belt 210 and chest and back parts of the shoulder straps 215, the sealing part 300 may be formed on the entire shoulder strap 215 as occasion demands. However, in consideration of convenience of worker's work, the sealing part 300 is preferably formed on the belt 210 or the chest and back parts of the shoulder straps 215 as shown in FIG. 17. Although it has been illustrated in FIG. 17 that the sealing part 300 is protruded to the outside of the safety vest 200, the sealing part 300 may be formed in a space between an inside skin contacting the wearer and an outer cover corresponding to the inside skin so as not to be protruded to the outside of the safety vest, as occasion demands.

In a case where a worker wearing the safety vest 200 according to the present invention is drowned into water, the worker can relatively easily exposes the worker's head and breathe by means of buoyancy generated from the sealing part 300. FIG. 21 is a schematic view showing a state that a person wearing the safety vest according to the present invention is drowned in water. The sealing part 300 is preferably provided with an air injection valve through which air can be injected into or deflated from the sealing part. Thus, in an emergency situation, the worker can easily float on the surface of the water by means of the buoyancy generated from the sealing part 300. Further, the LED assemblies enable the worker to be easily searched and rescued by other people.

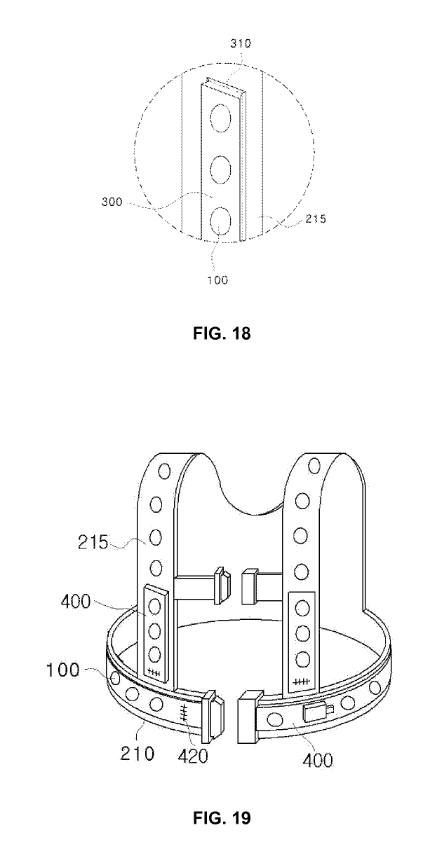

In the present invention, when air is deflated from the sealing part, the safety vest necessarily has the shape of a thin safety vest, like the conventional safety vest. Therefore, a folding line is formed at a central part in the thickness of the sealing part. When the air is deflated from the sealing part, the sealing part is completely adhered closely to the safety vest by folding a folding part, so that the safety vest has the shape of a safety vest having no sealing part. FIG. 18 is a view showing another embodiment of the sealing part, which shows an enlarged view of part A in FIG. 17. As shown in FIG. 18, a folding line 310 is formed on a side surface of the sealing part 300. The folding line 310 is folded while the air in the sealing part 300 is deflated from the sealing part, so that the sealing part 300 having the air deflated therefrom has a usual shape of the shoulder strap 215. When the air is deflated from the sealing part 300, the sealing part may be provided with an attaching means (not shown) such as a Velcro tape, formed at front and rear parts of the folding line 310, so that the front and rear parts of the folding line can be adhered closely to each other about the folding line.

FIG. 19 is a schematic view of the safety vest having a shoulder strap with an accommodating part as another embodiment of the present invention. The accommodating part 400 is provided to the safety vest 200, and an air bag having the shape of the accommodating part 400 may be inserted into or separated from the accommodating part 400. To this end, a gateway for entrance/exit of the air bag is provided to the accommodating part 400, and an opening/closing means 420 such as a zipper is attached to the gateway. The worker normally uses the safety vest without the air bag. However, when the worker works at a place where the worker may be drowned in water, the worker inserts the air bag into the safety vest and then works. Like the sealing part 300, the accommodating part 400 is preferably formed on the belt 210 or the chest and back parts of the shoulder straps 215. Although it has been illustrated in FIG. 19 that the accommodating part 400 is protruded from the outside of the safety vest 200, the accommodating part may be formed in a space between an inside skin contacting the wearer and an outer cover corresponding to the inside skin so as not to be protruded to the outside of the safety vest, as occasion demands. Like the sealing part, a folding line and an attaching means are preferably provided to the accommodating part 400.

The battery 600 is used to supply power to the LED assemblies 100, and the switch 700 is used to control electrical connection between the battery and the LED assemblies 100. The battery 600 and the switch 700 are mounted at an appropriate position of the safety vest 200.

The safety vest 200 according to the present invention may be used in water. Preferably, products having a waterproof function are used as the battery 600, the switch 700 and the LED assemblies 100, which are related to electricity.

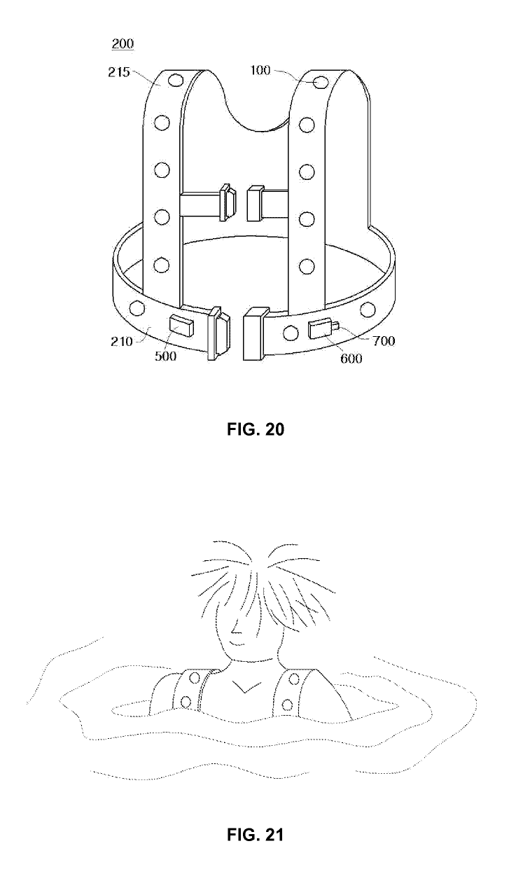

In a case where a distress signal transmitter for generating a distress signal may be attached to the safety vest so that a wearer drowned in the sea can be easily rescued. FIG. 20 is a schematic view of the safety vest having a distress signal transmitter attached thereto. The distress signal transmitter 500 receives power supplied from the battery 600 and transmits a distress signal. Then, a rescue team receives the distress signal transmitted from the distress signal transmitter using a distress signal receiver, so that it is possible to easily detect the position of a survivor. The distress signal transmitter and the distress signal receiver use a technique known in the art, and therefore, their detailed descriptions will be omitted.

### INDUSTRIAL APPLICABILITY

The safety vest according to the present invention is used by attaching specifically designed LED assemblies to the convention safety vest, so that it is possible to prevent the safety vest from being easily damaged and improve visibility, thereby protecting a worker from an unexpected accident. Further, the safety vest is provided with a buoyancy generation means without a decrease in the worker's work ability, so that it is possible to maximize worker's survival time and to allow the worker to be easily rescued.

Although the present invention has been described in detail in connection with the specific embodiments, it will be readily understood by those skilled in the art that various modifications and changes can be made thereto within the technical spirit and scope of the present invention. It is also apparent that the modifications and changes fall within the scope of the present invention defined by the appended claims.

1. A safety vest having a belt for surrounding a person's waist and shoulder straps connected to the belt respectively thrown on person's shoulders, the safety vest comprising:
a plurality of LED assemblies attached to a surface of the safety vest;
a battery for supplying power to the LED assemblies; and
a switch for controlling the power of the battery,
wherein each of the LED assemblies comprises:
at least one LED;
a light transmitting unit configured to protect the LED from external shock by surrounding an emission part of the LED and transmit light of the LED to an outside thereof, the light transmitting unit comprising at least one thin film light transmitting portion of which thickness is thin in the light transmitting unit so as to ease the glare of intense light just in front of the LED and to improve visibility at a long distance, and at least one thick film light transmitting portion of which thickness is thicker than that of the thin film light transmitting portion in the light transmitting unit so as to emit the light to sides of the LED by widely diffusing the light of the LED; and
a fixing part positioned on a bottom surface of the LED.

2. The safety vest of claim 1, wherein at least one sealing part having a sealed inside is provided to the safety vest, and an air injection valve through which air is injected into or deflated from the sealing part is provided to the sealing part.

3. The safety vest of claim 1, wherein at least one accommodating part is provided to the safety vest, a gateway through which an air bag is inserted into or separated from the accommodating part is provided to the accommodating part, and an opening/closing means is provided to the gateway.

4. The safety vest of claim 2, wherein the sealing part is formed on only parts of the belt or shoulder strap, which come in contact with person's chest and back.

5. The safety vest of claim 2, wherein a folding line is formed at a central part in a thickness direction of the sealing part.

6. The safety vest of claim 5, wherein a folding line is formed at a central part in a thickness direction of the accommodating part or sealing part, and when air is deflated from the accommodating part or sealing part, an attaching means is formed at front and rear parts of the folding line so that the front and rear parts of the folding line is adhered closely to each other about the folding line.

7. The safety vest of claim 1, wherein the LED is a high-brightness LED.

8. The safety vest of claim 1, wherein the LED assembly, the battery and the switch have a waterproof function.

9. The safety vest of claim 1, wherein the LED assembly further comprises a base, and the base comprises a support part having the fixing part accommodated in an inside thereof and having a frame provided thereto; a sidewall connected upward from the support part so as to surround the LED; and a wire connection groove having an electric wire accommodated therein, wherein the electric wire is formed by horizontally passing through the support part so as to be connected to the LED by connection screws respectively passing through positive and negative electrodes of the LED formed on the fixing part.

10. The safety vest of claim 1, wherein the LED assembly further comprises a base, and the base comprises a support part having a bottom opening through which the LED is inserted into the light transmitting unit at a bottom thereof; and a sidewall connected upward from the support part so as to surround the LED.

11. The safety vest of claim 1, wherein a concave part having a relatively small diameter is formed in the light transmitting unit.

12. The safety vest of claim 1, wherein at least one fixing pin is attached to a bottom of the fixing part.

13. The safety vest of claim 1, wherein a light diffusion cap surrounding the LED is formed at an outside of the LED, a bottom of the light diffusion cap is coupled to the fixing part, the light diffusion cap has a shape in which a thin wall is formed along a side of the LED from the bottom of the fixing part, and a convex, concave or flat lens for light diffusion is then formed above the LED.

14. The safety vest of claim 1, wherein a polycarbonate layer is additionally attached to a top of the light passing unit.

15. The safety vest of claim 1, wherein a diffusion layer is additionally attached to an inside of the light transmitting unit, opposite to a top of the LED.

16. The safety vest of claim 1, wherein at least one air exhaustion groove or embossing is formed on a side surface of the light-passing unit, which comes in contact with the LED.

17. The safety vest of claim 1, wherein the fixing part has a connector shape.

18. The safety vest of claim 1, wherein a distress signal transmitter is attached to the safety vest.

19. The safety vest of claim 3, wherein the accommodating part is formed on only parts of the belt or shoulder strap, which come in contact with person's chest and back.

20. The safety vest of claim 3, wherein a folding line is formed at a central part in a thickness direction of the accommodating part.
